(19) United States
(12) Patent Application Publication
(10) Pub. No.: US 2025/0174672 A1
(43) Pub. Date: May 29, 2025

(54) METHOD OF MANUFACTURING LAMINATED CERAMIC ALL-SOLID-STATE BATTERY

(71) Applicant: KOREA ELECTRONICS TECHNOLOGY INSTITUTE, Seongnam-si (KR)

(72) Inventors: Intae SEO, Seongnam-si (KR); Hyung Won KANG, Seoul (KR); Chul Min OH, Yongin-si (KR)

(21) Appl. No.: 18/961,023

(22) Filed: Nov. 26, 2024

(30) Foreign Application Priority Data
Nov. 29, 2023 (KR) 10-2023-0169898

(51) Int. Cl. H01M 4/66; H01M 4/04; H01M 4/583; H01M 50/437

(52) U.S. Cl. CPC H01M 4/661; H01M 4/0471; H01M 4/583; H01M 50/437

(57) ABSTRACT

Proposed is a method of manufacturing a laminated ceramic all-solid-state battery. The method may include sequentially laminating a first current collector layer, a cathode active material layer, a solid electrolyte layer, an anode active material layer, and a second current collector layer to form a laminate sheet. The method may also include sintering the laminate sheet at a temperature of 500 to 600° C. under a reducing atmosphere. The anode active material layer may contain graphite, and the first and second current collector layers may contain a metal. The method can enable ceramic materials within a battery to be simultaneously sintered at a lower temperature than a conventional ceramic sintering temperature, thus preventing damage to the battery at high temperatures and diversifying the materials constituting the battery.

### CROSS REFERENCE TO RELATED APPLICATION

The present application claims priority to Korean Patent Application No. 10-2023-0169898, filed Nov. 29, 2023, the entire contents of which is incorporated herein for all purposes by this reference.

### BACKGROUND

### Technical Field

The present disclosure relates to a method of manufacturing a laminated ceramic all-solid-state battery.

### Description of Related Technology

All-solid-state batteries using oxide-based solid electrolytes have advantages of having higher stability than conventional lithium-ion batteries using liquid electrolytes, of being miniaturized because they can produce high power in a small volume, and of being directly mounted on a printed circuit board (PCB). Recently, as the demand for wearable devices such as smartwatches, earbuds, and smart rings has increased, there has been increasing demand for development of high-power, ultra-small multilayer ceramic all-solid-state batteries by formation of these all-solid-state batteries in a multilayer form and to replace conventional liquid electrolyte-based coin cells.

### SUMMARY

One aspect is a method of manufacturing a laminated ceramic all-solid-state battery by simultaneously sintering a cathode active material, a cathode active material, and a solid electrolyte at a temperature lower than a conventional ceramic sintering temperature.

Another aspect is a method of manufacturing a laminated ceramic all-solid-state battery, the method including sequentially laminating a first current collector layer, a cathode active material layer, a solid electrolyte layer, an anode active material layer, and a second current collector layer to form a laminate sheet, and sintering the laminate sheet at a temperature of 500 to 600° C. under a reducing atmosphere, wherein the anode active material layer contains graphite, and the first and second current collector layers contain a metal.

In an embodiment, the cathode active material layer may contain a lithium-based oxide.

In an embodiment, the solid electrolyte layer may contain a Li—Si-based amorphous glass.

In an embodiment, the first and second current collector layers may contain Cu, Li, Al, or a combination thereof.

In an embodiment, a partial pressure of oxygen in the reducing atmosphere may be 10⁻¹⁸ to 10⁻⁷ atm.

In an embodiment, a fraction of nitrogen in the reducing atmosphere may be 99.4 to 99.8%.

In an embodiment, a fraction of hydrogen in the reducing atmosphere may be 0.1 to 0.5%.

In an embodiment, a wetter temperature in the reducing atmosphere may be 40 to 70° C.

### BRIEF DESCRIPTION OF THE DRAWINGS

The above and other objects, features, and other advantages of the present disclosure will be more clearly understood from the following detailed description taken in conjunction with the accompanying drawings.

FIG. 1, FIGS. 2A and 2B, and FIGS. 3A and 3B show X-ray diffraction patterns depending on temperature and atmosphere changes of a solid electrolyte, a composite of a cathode active material and a solid electrolyte, and a composite of an anode active material and a solid electrolyte according to one embodiment.

FIGS. 4A to 4F, FIGS. 5A to 5F, and FIGS. 6A to 6F illustrate changes in microstructure depending on temperature and atmosphere changes of a solid electrolyte, a composite of a cathode active material and a solid electrolyte, and a composite of an anode active material and a solid electrolyte according to one embodiment.

FIG. 7 is a graph showing a comparison in changes in ionic conductivity depending on a sintering atmosphere of a solid electrolyte, and a composite of a cathode active material and a solid electrolyte according to one embodiment.

### DETAILED DESCRIPTION

In order to produce a laminated ceramic all-solid-state battery, a composite cathode including a cathode active material and a solid electrolyte, a composite anode including an anode active material and a solid electrolyte, a solid electrolyte, and a transition metal current collector should be simultaneously laminated in multiple layers and then simultaneously sintered. Typically, a high temperature of 1,000° C. or higher is required for sintering of ceramics. At such high temperatures, the ceramics constituting the all-solid-state battery may be volatilized or damaged. Therefore, it is important to control the conditions of the sintering process.

The objects described above, features and advantages will be clearly understood from the following preferred embodiments with reference to the attached drawings. However, the present disclosure is not limited to the embodiments. In the following description of the present disclosure, detailed descriptions of related art will be omitted when they may obscure the subject matter of the present disclosure.

According to one aspect of the present disclosure, a method of manufacturing a laminated ceramic all-solid-state battery is provided, the method including sequentially laminating a first current collector layer, a cathode active material layer, a solid electrolyte layer, an anode active material layer, and a second current collector layer to form a laminate sheet, wherein the anode active material layer contains graphite, and the first and second current collector layers contain a metal, and sintering the laminate sheet under a reducing atmosphere at a temperature of 500 to 600° C.

The first and second current collector layers are layers that function to transfer electrons from the outside to the active material (the first current collector layer) or to discharge electrons from the active material to the outside (the second current collector layer) so that an electrochemical reaction can occur in the battery when the battery is charged/discharged. In the laminated ceramic all-solid-state battery, the first and second current collector layers are laminated adjacent to the cathode active material layer and the anode active material layer, respectively, and function to transfer electrons to the cathode active material layer and the anode active material layer or to discharge electrons therefrom upon charging/discharging. The first and second current collector layers contain a metal and the metal has high electrical conductivity and thus facilitates electron movement through the current collector layer.

In one embodiment, the first and second current collector layers may contain Cu, Li, Al, or a combination thereof. The metal contained in the current collector layer must have high electrical conductivity. In this regard, Cu, Li, Al, or a combination thereof is suitable for use as a current collector. In addition, the metal also has an advantage in terms of price. Specifically, preferably, Cu and Al are contained in the current collector layer in consideration of electrical conductivity, price, and oxidation stability. The cathode active material layer refers to a layer containing a cathode active material that receives electrons from the first current collector layer, when the battery is charged, and is reduced along with a cation. When the battery is charged, once electrons are supplied to the cathode active material layer, the cathode active material is reduced and the cations are released to the electrolyte layer, and then the released cations generate electricity in the anode active material layer. The cathode active material layer affects the capacity and output of the battery. In particular, the cations released from the cathode active material layer function to generate electricity. Therefore, a material that facilitates generation of cations during charging is preferably contained in the cathode active material layer.

In one embodiment, the cathode active material layer may contain a lithium-based oxide. The cathode active material layer containing a lithium cation with high diffusivity may easily generate cations and diffuse the same into the solid electrolyte layer during charging, thereby improving battery capacity and output. The lithium-based oxide contained in the cathode active material layer may be, for example, LiCoO₂ (LCO), Li(Ni, Co, Mn)O₂ (NCM), Li(Ni, Co, Al)O₂(NCA),LiMn₂O₄(LMO), or LiFePO₄ (LFP) and is preferably LCO in consideration of all of battery lifespan, power, and ease of subsequent low-temperature sintering.

The solid electrolyte layer functions to transfer cations released from the cathode active material layer to the anode active material layer when the battery is charged. Unlike a liquid electrolyte, a solid electrolyte does not require a separator to separate the electrolyte from the electrode, thus enabling manufacture of a more compact battery, increasing the battery capacity per unit volume, and exhibiting superior stability compared to a battery using a liquid electrolyte. Any material may be contained in the solid electrolyte layer without limitation as long as it is densified with the adjacent cathode active material layer and anode active material layer by sintering, and such a material may include, for example, a ceramic containing Li oxide.

In one embodiment, the solid electrolyte layer may include a Li—Si amorphous glass. Unlike conventional ceramics that are generally sintered at a high temperature of about 800° C. or higher, Li—Si amorphous glass may be sintered even at a low temperature of 600° C. or lower, and thus has an advantage of being sintered even in the low-temperature simultaneous sintering of the present disclosure.

The anode active material layer receives and stores cations that are released from the cathode active material layer and move through the solid electrolyte layer, when the battery is charged, and then releases the cations through the solid electrolyte layer and transfers the cations back to the cathode active material layer when the battery is discharged, thereby generating electricity. The cathode active material layer contains graphite and the graphite has a structure in which a plurality of graphenes is laminated. When the battery is charged, cations are stored in the space between graphenes in the graphite, and then discharged back to the solid electrolyte layer when the battery is discharged, thereby generating electricity. Due to the laminated graphene structure as described above, graphite has a high battery capacity.

During the lamination, these layers are laminated in the order of a first current collector layer, a cathode active material layer, a solid electrolyte layer, an anode active material layer, and a second current collector layer to form a laminate sheet.

Since sulfide-based all-solid-state batteries and polymer-based all-solid-state batteries are manufactured by lamination rather than sintering, a conductive binder is contained as a conductive material in the cathode, the anode, and the electrolyte. On the other hand, the laminated ceramic all-solid-state battery of the present disclosure does not include a separate additive such as a binder, and thus has higher stability and reliability than sulfide-based all-solid-state batteries and polymer-based all-solid-state batteries.

The method includes sintering the laminate sheet at a temperature of 500 to 600° C. under a reducing atmosphere. The cathode active material layer, the solid electrolyte layer, and the anode electrolyte layer of the laminate sheet include a ceramic material as described above, and typically, sintering of the ceramic material is performed at a high temperature of about 800° C. or higher. However, the laminate sheet contains graphite as the anode active material and the graphite volatilizes even at a temperature of about 500° C. in the air and thus volatilizes when the reaction temperature for sintering the laminate sheet is set to 800° C. or higher. The method enables sintering the laminate sheet even at a temperature of 500 to 600° C., which is lower than a typical sintering temperature, by adjusting the sintering atmosphere to a reducing atmosphere. As used herein, the term “reducing atmosphere” refers to an atmosphere within a reactor in which the laminate sheet is sintered that may donate hydrogen or electrons to the laminate sheet, and specifically refers to a state in which the partial pressure of hydrogen is increased compared to the air. In a non-reducing atmosphere, the graphite of the anode active material layer and the metal of the first and second laminates may volatilize. In a reducing atmosphere, when the sintering temperature is less than 500° C., the thermal energy required for sintering the ceramic contained in the laminate sheet may be insufficient, thus making sintering difficult. When the sintering temperature exceeds 600° C., the graphite in the anode active material layer may rapidly volatilize and be damaged. Specifically, the sintering may be performed in a reducing atmosphere at a temperature of 500 to 550° C., more specifically, at a temperature of 500 to 530° C. The method enables respective layers of the laminate sheet to be simultaneously sintered under the sintering temperature and atmosphere described above, thereby allowing the ceramic material used in the ceramic all-solid-state battery to be diversified to two or more types without an adhesive or a corresponding buffer layer between the layers, and simplifying the process configuration.

In one embodiment, the oxygen partial pressure in the reducing atmosphere may be 10⁻¹⁸ to 10⁻⁷ atm. When the oxygen partial pressure in the reducing atmosphere is less than 10⁻¹⁸ atm, phase collapse may occur due to volatilization of specific component, especially Li, in the cathode active material layer and the solid electrolyte layer, which may significantly deteriorate the battery performance, and when the oxygen partial pressure in the reducing atmosphere exceeds 10⁻⁷ atm, rapid volatilization may occur due to oxidation of graphite in the anode active material layer. Specifically, the oxygen partial pressure in the reducing atmosphere may be 10⁻¹⁵ to 5×10⁻⁸ atm, more specifically 10⁻¹² to 10⁻⁵ atm.

In one embodiment, the nitrogen fraction in the reducing atmosphere may be 99.4 to 99.8%. When the nitrogen fraction in the reducing atmosphere is less than 99.4% and more than 99.8%, a problem may occur in which the graphite and the solid electrolyte layer contained in the anode active material layer of the laminate sheet volatilize at the sintering temperature.

In one embodiment, the fraction of hydrogen in the reducing atmosphere may be 0.1 to 0.5%. When the fraction of hydrogen in the reducing atmosphere is less than 0.1%, a problem in which the cathode active material layer and the solid electrolyte layer are oxidized during the sintering process may occur, and when the fraction of hydrogen in the reducing atmosphere is more than 0.5%, the cathode and anode active material layers may volatilize during the sintering process.

In one embodiment, the wetter temperature in the reducing atmosphere may be 40 to 70° C. The term “wetter temperature” used herein refers to a temperature of a tank containing water (H₂O) used to control the oxygen partial pressure in the reducing atmosphere described above. Specifically, the partial pressure of oxygen in a reducing atmosphere is determined by the equilibrium of the following formula:

H₂(g)+1/2O₂(g)→H₂O(g)

Here, when the wetter temperature increases and the water vapor partial pressure in the reducing atmosphere increases, the reverse reaction proceeds to achieve an equilibrium state and thus the oxygen partial pressure increases, and when the wetter temperature decreases and the water vapor partial pressure decreases, the forward reaction proceeds to achieve an equilibrium state, and thus the oxygen partial pressure decreases. When the wetter temperature in the reducing atmosphere is less than 40° C. or more than 70° C., the oxygen partial pressure in the reducing atmosphere described above is not satisfied and thus battery performance may deteriorate due to volatilization of one or more of the cathode active material layer, the solid electrolyte layer, and the anode active material layer during the sintering.

Hereinafter, preferred examples are provided for better understanding of the present disclosure and the following examples should not be construed as limiting the disclosure.

### Experimental Example 1—Phase Change and Microstructural Change of Solid Electrolyte Layer Depending on Changes in Sintering Atmosphere and Sintering Temperature

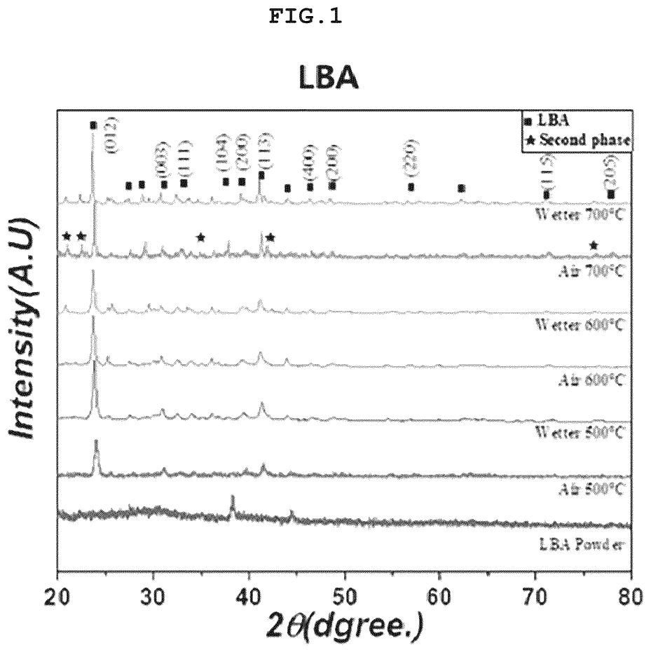

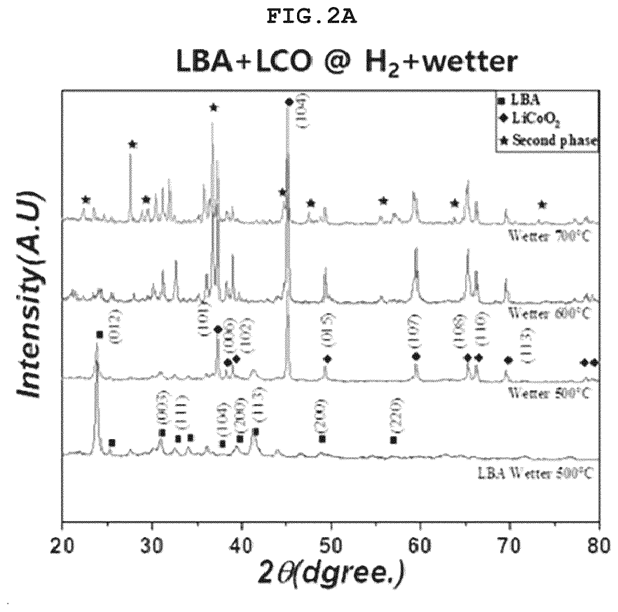

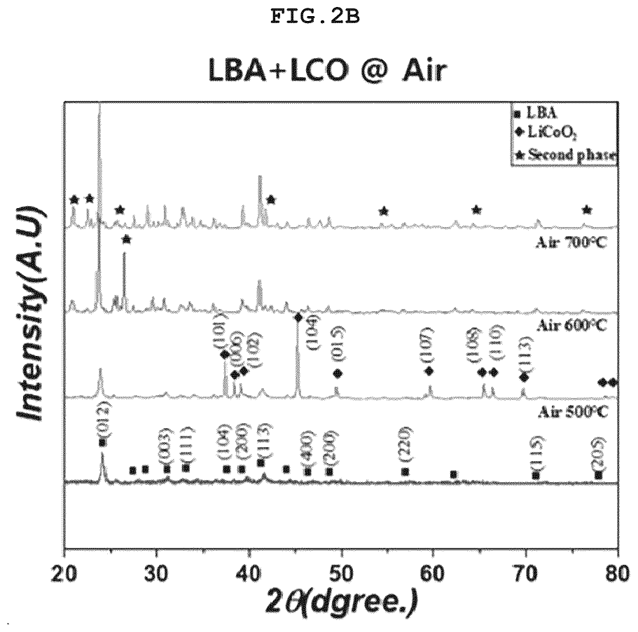

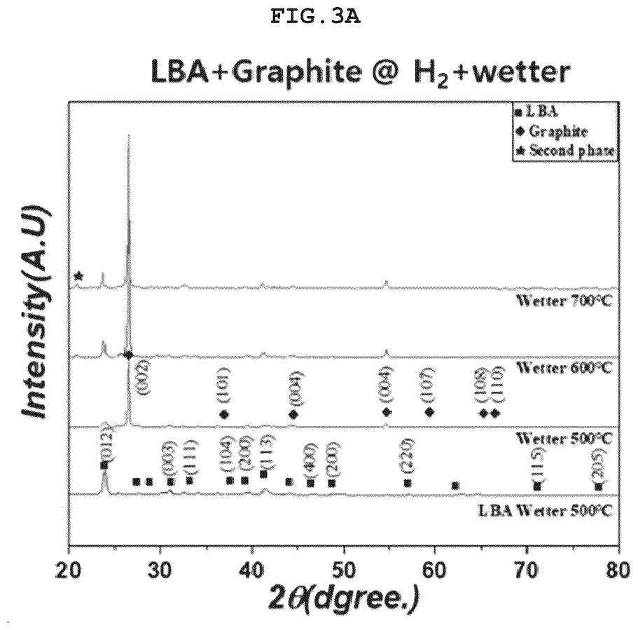

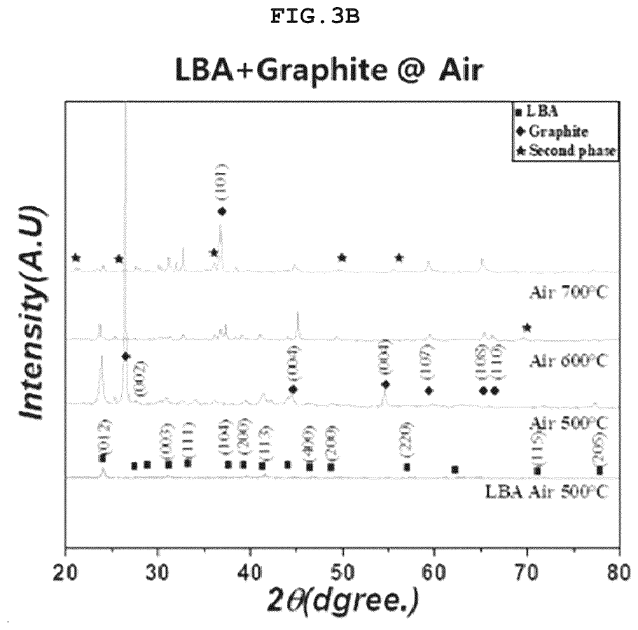

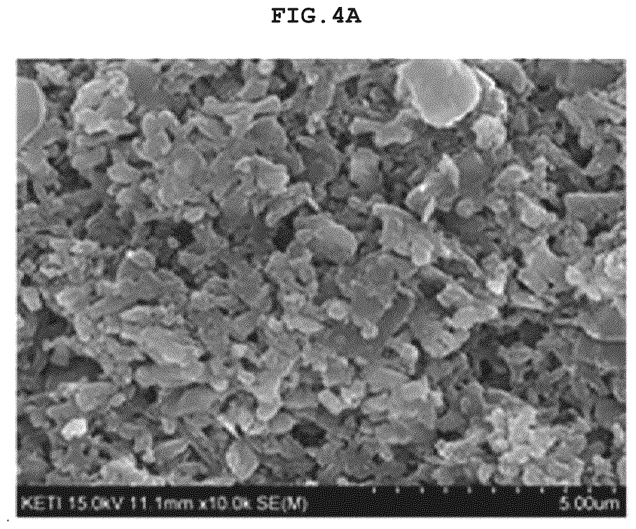

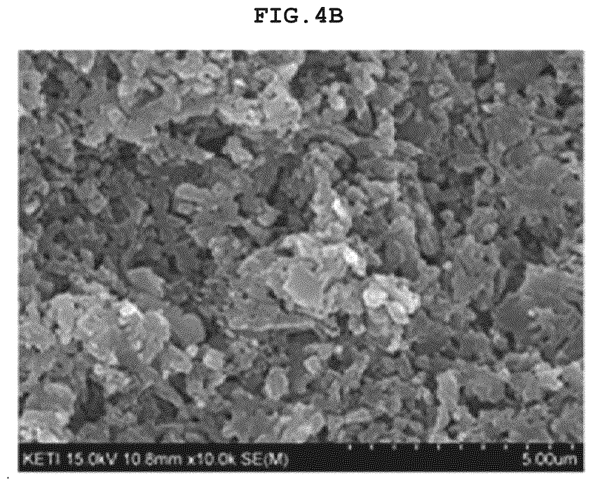

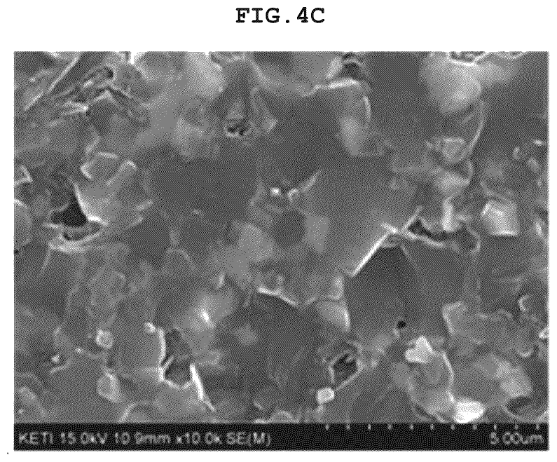

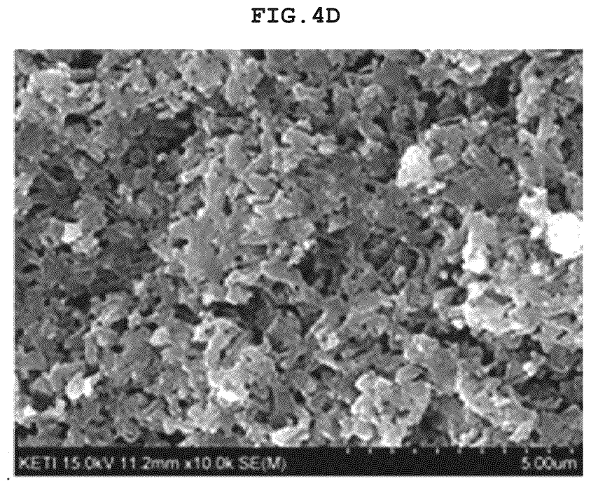

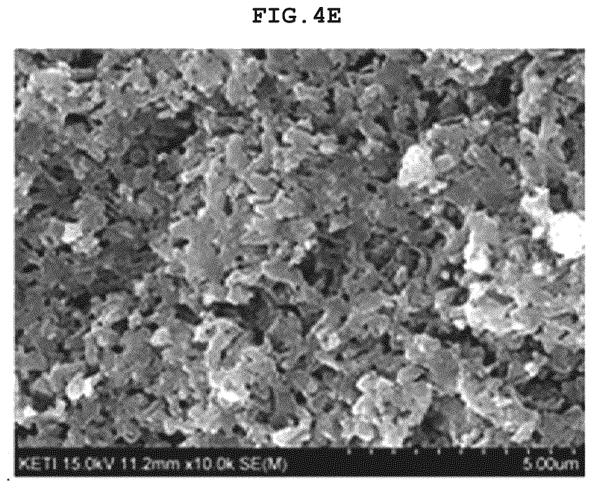

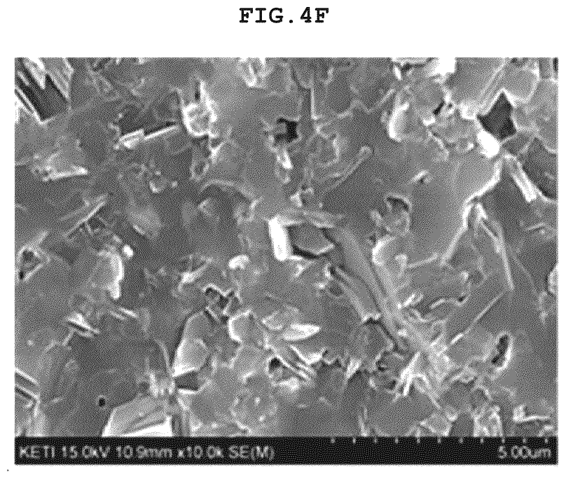

Six Li—Si amorphous oxide-based solid electrolyte powders (hereinafter referred to as “LBAs”) were molded in the form of discs having a diameter of 10 mm. Among these, three solid electrolyte layers formed in the form of discs were sintered at predetermined sintering temperatures of 500, 600, and 700° C. under a reducing atmosphere (wetter) containing an oxygen partial pressure of 10⁻¹⁰ atm, a nitrogen fraction of 99.5%, and a hydrogen fraction of 0.04%. The other three solid electrolyte layers were sintered at sintering temperatures of 500, 600, and 700° C. in the air. Then, the phase changes of these six solid electrolyte layers depending on the changes in the sintering atmosphere and sintering temperature were determined by analyzing X-ray diffraction patterns thereof, and the changes in the microstructure depending on the changes in the sintering atmosphere and sintering temperature were determined using a scanning electron microscope (SEM). The X-ray diffraction patterns of the solid electrolyte layers are shown in FIG. 1 and the SEM images of the microstructure are shown in FIGS. 4A to 4F. FIGS. 4A to 4C are SEM images showing the solid electrolyte layers sintered at temperatures of 500, 600, and 700° C. in the air, respectively, and FIGS. 4D to 4F are SEM images showing the solid electrolyte layers sintered at temperatures of 500, 600, and 700° C. in a reducing atmosphere, respectively.

As can be seen from FIG. 1, the solid electrolyte layers including LBAs generally exhibited similar X-ray diffraction peaks, but an undesired second phase was formed when sintered at a temperature of 700° C. in the air.

As can be seen from FIGS. 4A to 4F, a denser microstructure was formed when sintered in a reducing atmosphere at the same sintering temperature.

### Experimental Example 2—Phase Change and Microstructural Change of Composite Cathode Layer Depending on Changes in Sintering Atmosphere and Sintering Temperature

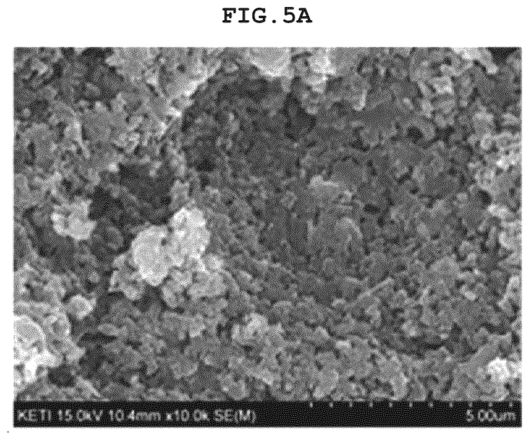

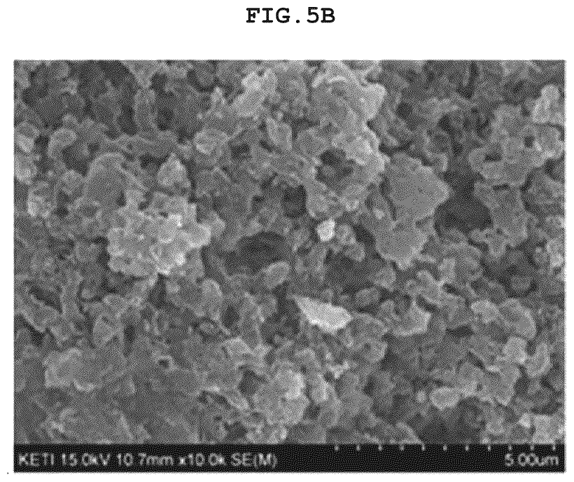

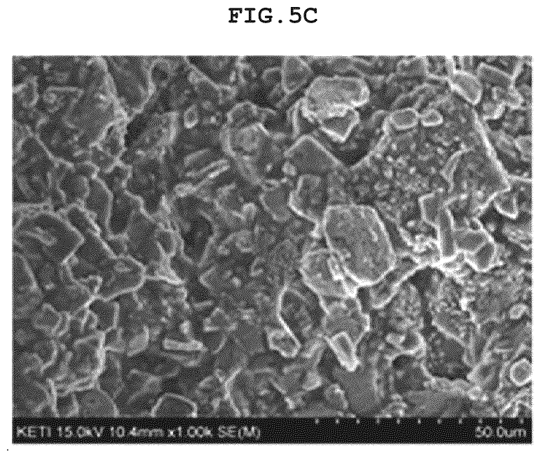

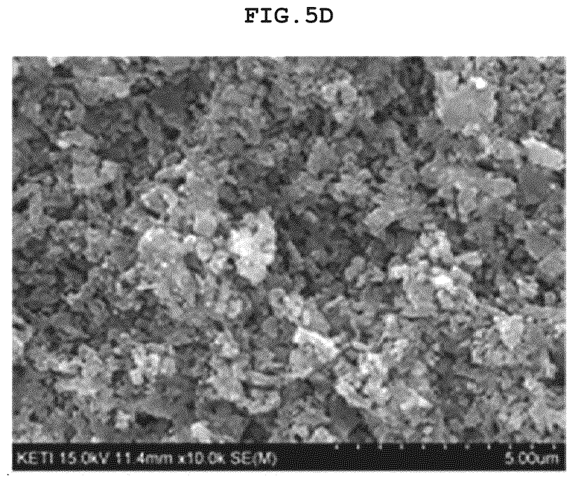

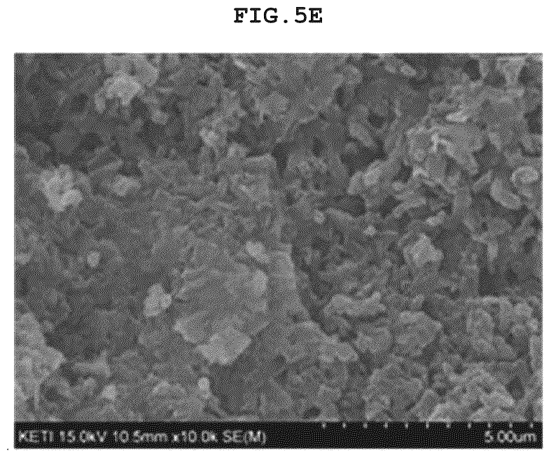

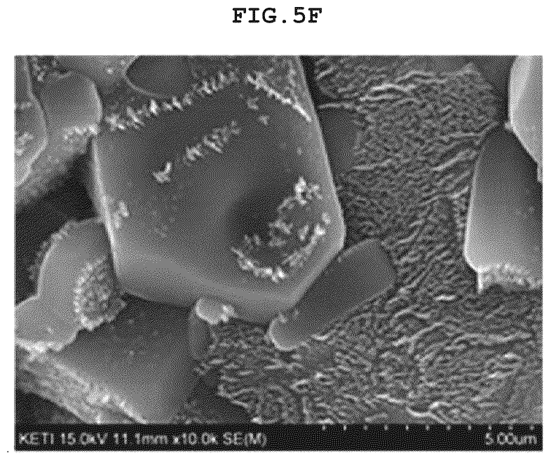

The LBA solid electrolyte and the cathode active material, LiCO₂ (LCO) were mixed in a ratio of 1:1 and molded in the form of a disc with a diameter of 10 mm. Six identical composite cathodes having the disc form were formed. Of these, three were sintered at sintering temperatures of 500, 600, and 700° C. under a reducing atmosphere containing an oxygen partial pressure of 10⁻¹⁰ atm, a nitrogen fraction of 99.5%, and a hydrogen fraction of 0.4%. The other three composite cathodes were sintered at sintering temperatures of 500, 600, and 700° C. in the air. Then, the phase changes of these six composite cathodes depending on the changes in the sintering atmosphere and sintering temperature were determined by analyzing X-ray diffraction patterns thereof, and the changes in the microstructure depending on the changes in the sintering atmosphere and sintering temperature were determined using a scanning electron microscope (SEM). The X-ray diffraction patterns of the composite cathodes sintered under a reducing atmosphere are shown in FIG. 2A, the X-ray diffraction patterns of the composite cathodes sintered in the air are shown in FIG. 2A, and the SEM images to confirm the microstructure are shown in FIGS. 5A to 5F. FIGS. 5A to 5C are SEM images showing the composite cathodes sintered at temperatures of 500, 600, and 700° C. in air, respectively, and FIGS. 5D to 5F are SEM images showing the composite cathodes sintered at temperatures of 500, 600, and 700° C. in a reducing atmosphere, respectively.

As can be seen from FIG. 2A, the composite cathode sintered under a reducing atmosphere did not generate secondary phases when the sintering temperature was 600° C. or lower, but large amounts of secondary phases were formed when the sintering temperature increased to 700° C. Meanwhile, as can be seen from FIG. 2B, the composite cathode sintered in the air produced secondary phases even at a sintering temperature of 600° C.

Comparing FIGS. 5A to 5C with FIGS. 5D to 5F, it can be seen that the composite cathode sintered in a reducing atmosphere exhibited a denser microstructure at the same sintering temperature. A rod-shaped microstructure of the secondary phase can be seen from FIGS. 5B, 5C, and 5F.

### Experimental Example 3—Phase Change and Microstructural Change of Composite Anode Layer Depending on Changes in Sintering Atmosphere and Sintering Temperature

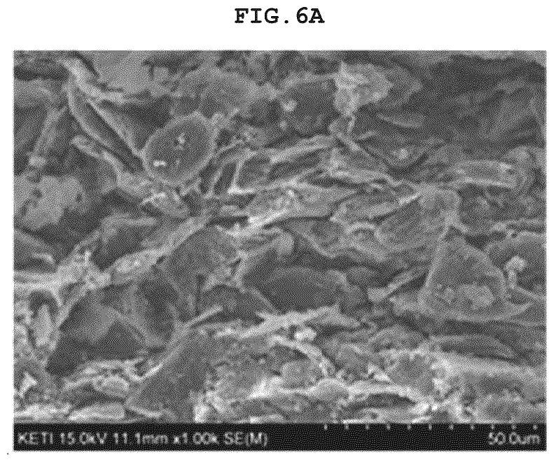

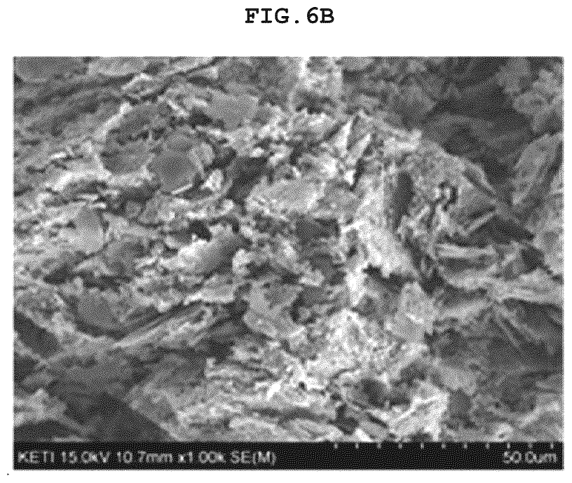

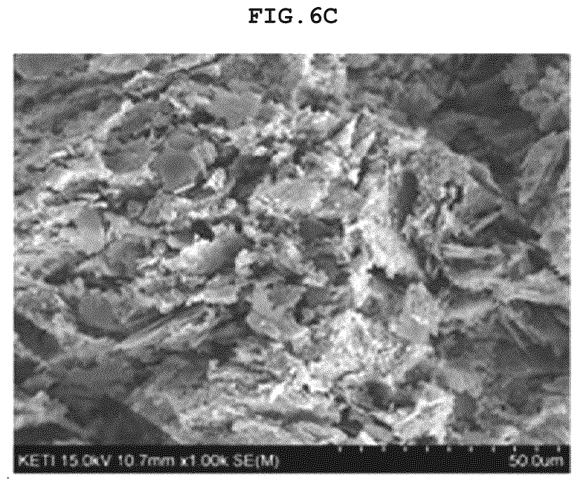

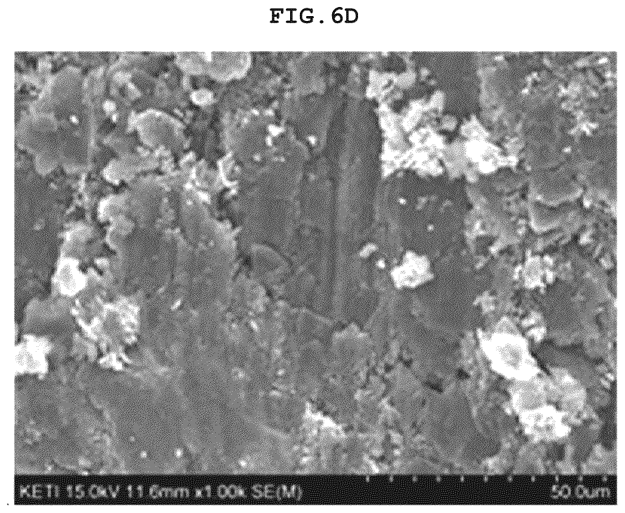

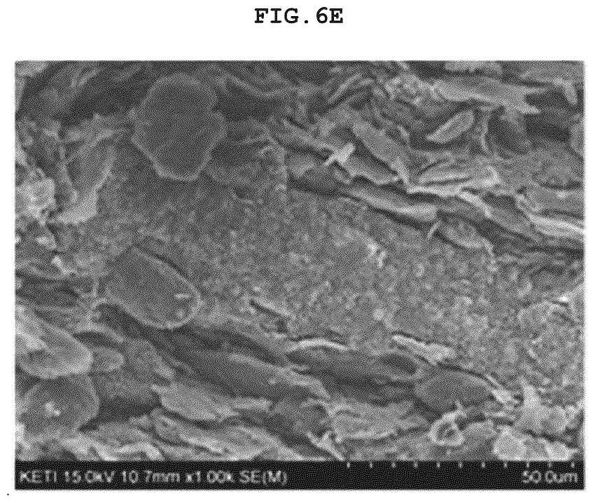

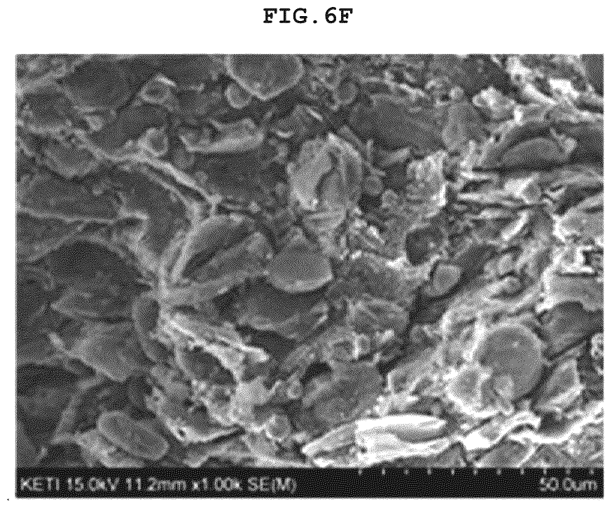

The LBA solid electrolyte and graphite as an anode active material were mixed in a ratio of 1:1 and molded in the form of a disc with a diameter of 10 mm. Six identical composite anodes having the disc form were formed. Of these, three were sintered at sintering temperatures of 500, 600, and 700° C. under a reducing atmosphere containing an oxygen partial pressure of 10⁻¹⁰ atm, a nitrogen fraction of 99.5%, and a hydrogen fraction of 0.4%. The other three composite anodes were sintered at sintering temperatures of 500, 600, and 700° C. in the air. Then, the phase changes of these six composite anodes depending on the changes in the sintering atmosphere and sintering temperature were determined by analyzing X-ray diffraction patterns thereof and the changes in the microstructure depending on the changes in the sintering atmosphere and sintering temperature were determined using a scanning electron microscope (SEM). The X-ray diffraction patterns of the composite anodes sintered under a reducing atmosphere are shown in FIG. 3A, the X-ray diffraction patterns of the composite anodes sintered in the air are shown in FIG. 3B, and the SEM images to confirm the microstructure are shown in FIGS. 6A to 6F. FIGS. 6A to 6C are SEM images showing the composite anodes sintered at temperatures of 500, 600, and 700° C. in the air, respectively, and FIGS. 6D to 6F are SEM images showing the composite anodes sintered at temperatures of 500, 600, and 700° C. in a reducing atmosphere, respectively.

As can be seen from FIG. 3A, the composite anode sintered under a reducing atmosphere did not generate secondary phases when the sintering temperature was 600° C. or lower, but secondary phases were formed when the sintering temperature increased to 700° C. Meanwhile, as can be seen from FIG. 3B, the composite anode sintered in the air produced secondary phases even at a sintering temperature of 600° C.

Comparing FIGS. 6A to 6C with FIGS. 6D to 6F, it can be seen that the composite anode sintered in a reducing atmosphere exhibited a denser microstructure at the same sintering temperature. A rod-shaped microstructure of the secondary phase can be seen from FIGS. 6B, 6C, and 6F.

### Experimental Example 4—Measurement of Ionic Conductivity Change Depending on Sintering Atmosphere of Solid Electrolyte Layer and Composite Anode

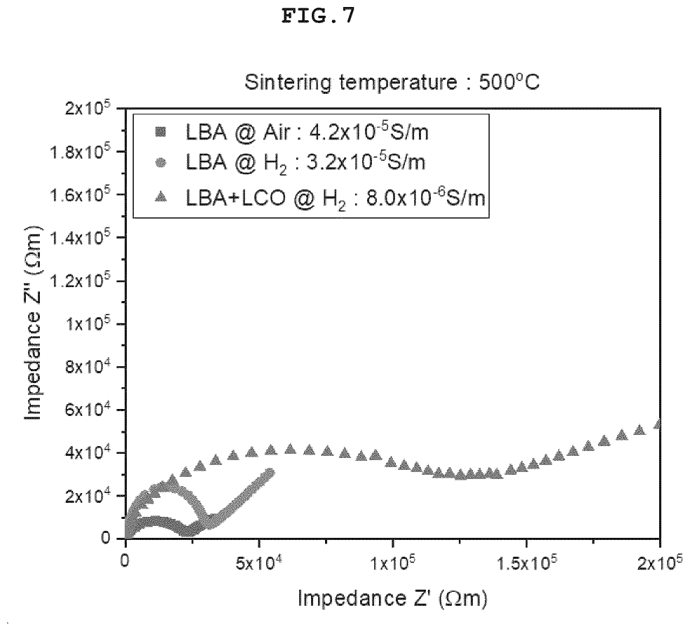

Impedance of the LBA solid electrolyte layer sintered in the air at a sintering temperature of 500° C. in Experimental Example 1, the LBA solid electrolyte layer sintered at a sintering temperature of 500° C. in a reducing atmosphere, and the composite cathode sintered at a sintering temperature of 500° C. in a reducing atmosphere in Experimental Example 2 was measured. Specifically, each specimen was mounted in a pressurizing jig and then the impedance was measured as a function of frequency from the terminals at both ends using an impedance analyzer in accordance with the method described in Journal of Applied Physics, 66, 3850 (1989) (D. C. Sinclair and A. R. West). The results of measurement are shown in FIG. 7. The measured impedance is a complex impedance, which consists of an imaginary part and a real part, and the imaginary part is plotted on the y-axis of the graph of FIG. 7, and the real part is plotted on the x-axis of the graph of FIG. 7.

As can be seen from FIG. 7, the x-intercept at the point where the semicircle part of the graph for each sample intersects the x-axis using extrapolation means the insulation resistance of each sample and the conductivity of each sample may be calculated from the x-intercept. The sample has electronic conductivity close to 0 and thus the conductivity is expressed as ionic conductivity. It can be seen from FIG. 7 that the ionic conductivity of the solid electrolyte layer sintered under a reducing atmosphere is similar to that of the solid electrolyte layer sintered in the air.

In addition, it can be seen that, although the cathode active material and the solid electrolyte layer are simultaneously sintered at a low temperature, like a composite cathode, when the sintering atmosphere is controlled to a reducing atmosphere, sufficient ionic conductivity to be used as a cathode of an all-solid-state battery can be obtained.

As apparent from the foregoing, according to the present disclosure, the laminated ceramic all-solid-state battery can be produced by sintering a laminate sheet in a low-temperature reducing atmosphere while minimizing damage to ceramics constituting the all-solid-state battery and the selection of materials constituting the respective layers can be diversified by simultaneously sintering respective layers of the laminated ceramic all-solid-state battery.

The present disclosure has been described in detail with reference to specific embodiments. The embodiments are provided only for better understanding of the disclosure and should not be construed as limiting the present disclosure. Those skilled in the art will appreciate that various modifications and improvements are possible, without departing from the scope and spirit of the invention as disclosed in the accompanying claims.

The modifications and improvements of the disclosure fall within the scope of the present disclosure and the specific scope of the present disclosure would be defined by the appended claims.

What is claimed is:

1. A method of manufacturing a laminated ceramic all-solid-state battery, the method comprising:
sequentially laminating a first current collector layer, a cathode active material layer, a solid electrolyte layer, an anode active material layer, and a second current collector layer to form a laminate sheet; and
sintering the laminate sheet at a temperature of 500° C. to 600° C. under a reducing atmosphere,
wherein the anode active material layer comprises graphite, and the first and second current collector layers comprise a metal.

2. The method according to claim 1, wherein the cathode active material layer comprises a lithium-based oxide.

3. The method according to claim 1, wherein the solid electrolyte layer comprises a Li—Si-based amorphous glass.

4. The method according to claim 1, wherein the first and second current collector layers comprise Cu, Li, Al, or a combination thereof.

5. The method according to claim 1, wherein a partial pressure of oxygen in the reducing atmosphere is 10⁻¹⁸ atm to 10⁻⁷ atm.

6. The method according to claim 1, wherein a fraction of nitrogen in the reducing atmosphere is 99.4% to 99.8%.

7. The method according to claim 1, wherein a fraction of hydrogen in the reducing atmosphere is 0.1% to 0.5%.

8. The method according to claim 1, wherein a wetter temperature in the reducing atmosphere is 40° C. to 70° C.
